(19) United States
(12) Patent Application Publication
(10) Pub. No.: US 2026/0339133 A1
(43) Pub. Date: Oct. 29, 2026

(54) PHOTONIC DEVICE WITH FLOATING GATES FOR ELECTROOPTICAL WAVEGUIDE TUNING

(71) Applicant: Tower Semiconductor Ltd., Migdal Haemek (IL)

(72) Inventors: Yakov Roizin, Migdal Haemek (IL); Avi Strum, Migdal Haemek (IL)

(73) Assignee: Tower Semiconductor Ltd., Migdal Haemek (IL)

(21) Appl. No.: 19/435,661

(22) Filed: Dec. 29, 2025

Related U.S. Application Data
(63) Continuation-in-part of application No. 19/419,067, filed on Dec. 14, 2025.
Application No. 19/419,067 is a continuation-in-part of application No. 19/211,265, filed on May 18, 2025.
Application No. 19/211,265 is a continuation-in-part of application No. 18/967,630, filed on Dec. 3, 2024.

(51) Int. Cl. G02F 1/035; G02F 1/03

(52) U.S. Cl. CPC G02F 1/035; G02F 1/0327; G02F 2202/105; G02F 2202/20

(57) ABSTRACT

A photonic device comprises a first item comprising one or more electrooptic elements made of an electrooptic material and surrounded by oxide. The photonic device comprises a second item bonded to the first item. The second item comprises one or more waveguides, floating gates made of a silicon based material and fully surrounded by oxide, and floating gate charge control elements spaced apart from the floating gates and configured to control a charge of each floating gate thereby controlling a refractive index of each electrooptic element. Each floating gate maintains its charge for long durations after being set. A distance between each floating gate and its closest electrooptic element is between 100-800 nanometers. The photonic device comprises a substrate.

### CROSS-REFERENCE TO RELATED APPLICATIONS

This application is a continuation in part of U.S. application Ser. No. 19/419,067, titled PHOTONIC DEVICE MANUFACTURING WITH SEQUENTIAL BONDING, filed Dec. 14, 2025, which is hereby incorporated by reference in its entirety.

### FIELD OF INVENTION

The present disclosure relates to silicon photonics devices and photonic integrated circuits fabricated by heterogeneous integration, and more particularly to tunable photonic waveguides comprising electrooptical materials using floating gates to control the refractive index of the electrooptical material through wafer bonding technology.

### BACKGROUND

Silicon photonics has emerged as a technology platform for photonic integrated circuits (PICs) that enables high-speed data transmission and optical signal processing. PICs fabricated using silicon photonics techniques can integrate various optical components including waveguides, modulators, and resonators on a single chip.

Electrooptical materials such as lithium niobate (LN), lithium tantalate, and barium titanate (BTO) exhibit the Pockels effect, wherein an applied electric field changes the refractive index of the material. This property makes such materials attractive for optical modulators and other photonic devices. Lithium niobate modulators, for example, can achieve bandwidths exceeding 200 GHz with low power operation, making them suitable for high-speed data transmission applications targeting 1.6 T and 3.2 T transmission speeds.

Waveguides in silicon photonics devices often exhibit variations due to several factors. Critical dimension variations in width, thickness, and sidewall angle of waveguides result from thin film lithography and etch limitations. Variations in the material's refractive index across the wafer are common, particularly for lithium niobate on insulator (LNOI) wafers. Additionally, the refractive index of electrooptical materials is temperature-dependent, causing PIC performance to drift as a function of temperature.

Tuning of photonic waveguides is desirable for various applications including wavelength-dependent operation such as wavelength selectivity in filters, demultiplexers, and modulators. Circuits for optical switching, beam steering for LiDAR, and quantum information processing benefit from tuning of phase and amplitude. Applications such as matching the shoulders of Mach-Zehnder Interferometers (MZI) or tuning the frequencies of micro-ring resonators (MRR) involve static changes rather than RF modulation.

Conventional approaches to tuning PICs include the use of power-consuming heaters, which are inefficient. Tuning silicon waveguides by changing free carrier dispersion through depletion of a P-N junction is not applicable to waveguides made of electrooptical materials.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a photonic device is provided. The photonic device comprises a first item comprising one or more electrooptic elements made of an electrooptic material and surrounded by oxide. The photonic device comprises a second item bonded to the first item. The second item comprises one or more waveguides. The second item comprises floating gates that are made of a silicon based material and are fully surrounded by oxide. The second item comprises floating gate charge control elements that are spaced apart from the floating gates and are configured to control a charge of each of the floating gates thereby controlling a refractive index of each of the one or more electrooptic elements. Each floating gate is configured to maintain its charge for long durations after the charge is set by one or more of the floating gate charge control elements. A distance between each silicon floating gate and an electrooptic element of the one or more electrooptic elements that is closest to the silicon floating gate is between 100-800 nanometers. The photonic device comprises a substrate.

According to other aspects of the present disclosure, the photonic device may include one or more of the following features. The floating gate charge control elements may comprise polysilicon electrodes that are fed by conductive paths of the second item. The floating gates may comprise a first floating gate and a second floating gate. The photonic device may further comprise a first sensing transistor configured to sense a first charge of the first floating gate and a second sensing transistor configured to sense a second charge of the second floating gate. The first floating gate may be a first gate electrode of the first sensing transistor and a first oxide region between the first floating gate and the first transistor may be a first oxide region of the first sensing transistor, wherein a first vertical channel of the first transistor is formed at a boundary between the first transistor and the first oxide region. The one or more electrooptic elements may comprise an electrooptic waveguide that is located below the first floating gate and the second floating gate, and a vertical projection of the electrooptic waveguide on a vertical plane may be positioned between vertical projections of the first floating gate and the second floating gate on the vertical plane. The one or more waveguides, the first floating gate and the second floating gate may be made of the same silicon based material. The one or more waveguides may be located at a same layer as the first floating gate and the second floating gate and to the side of the first floating gate and the second floating gate. The one or more electrooptic elements may comprise an unpatterned electrooptic layer that is located below the first floating gate and the second floating gate, and a waveguide of the one or more waveguides may have a vertical projection on a vertical plane that is positioned between vertical projections of the first floating gate and the second floating gate on the vertical plane. The waveguide may be made of silicon and may be located at a same level as the first floating gate and the second floating gate. The floating gate charge control elements may comprise polysilicon electrodes, and the waveguide may be made of silicon nitride and may be located at a same level as the polysilicon electrodes.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a cross-sectional view of a bonded structure comprising a photonic device with floating gates, according to aspects of the present disclosure.

FIG. 2 illustrates electrical field lines between floating gates in the bonded structure of FIG. 1, according to an embodiment.

FIG. 3 illustrates a cross-sectional view of a photonic device with floating gates and an electrooptical waveguide, according to aspects of the present disclosure.

FIG. 4 illustrates a cross-sectional view of a photonic device with an unpatterned electrooptical layer, according to an embodiment.

FIG. 5 illustrates electrical field lines between floating gates in the photonic device of FIG. 4, according to aspects of the present disclosure.

FIG. 6 illustrates a cross-sectional view of a photonic device with a silicon nitride waveguide, according to an embodiment.

FIG. 7 illustrates electrical field lines between floating gates in the photonic device of FIG. 6, according to aspects of the present disclosure.

FIG. 8 illustrates a top view of a photonic device with floating gates and electrodes, according to an embodiment.

FIG. 9 illustrates a flowchart for a method of fabricating a photonic device, according to aspects of the present disclosure.

FIG. 10 illustrates a flowchart for a method of operating a photonic device, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

It was found that the Pockels effect can be used to change the refractive index of electrooptical materials by applying external voltages. It ius highly beneficial to use said effect without direct electrical connections to waveguides—as direct electrical connections are not suitable for modulating or tuning dielectric waveguides such as those made of lithium niobate, lithium tantalate, or BTO.

Floating gates made of polysilicon or silicon nitride have been considered for various applications, but such materials may exhibit poor charge retention characteristics. Accordingly, there remains a desire for improved approaches to tuning photonic waveguides comprising electrooptical materials.

The tuning may be used for matching shoulders of Mach-Zehnder Interferometers (MZI) or tuning frequencies of micro-ring resonators (MRR). The photonic device 30C may be used for wavelength-dependent operation such as wavelength selectivity for filters, demultiplexers, and modulators. In some cases, the photonic device 30C may be used for circuits for optical switching, beam steering for LiDAR, or quantum information processing requiring tuning of phase and amplitude.

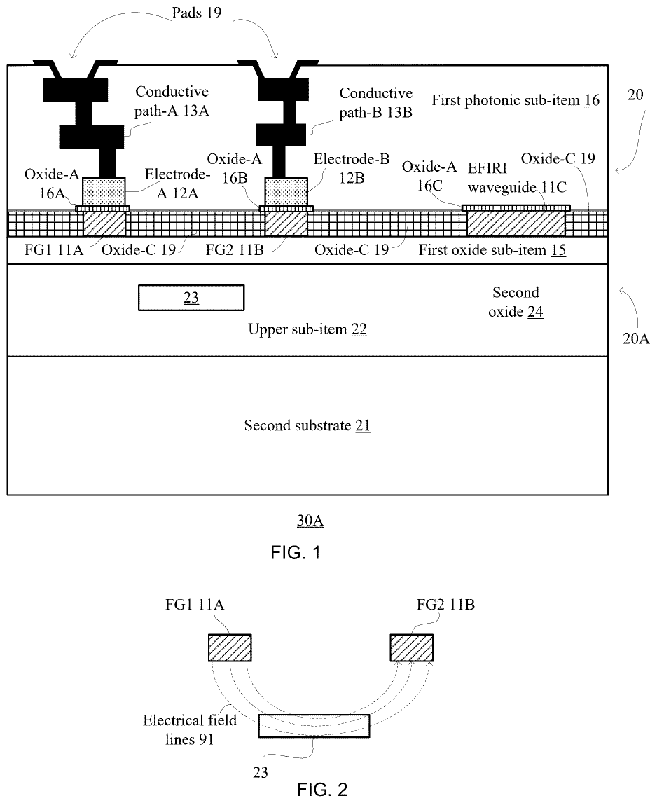

Referring to FIGS. 1-2, a bonded structure 30A comprises a photonic device with floating gate elements configured for tuning electrooptical waveguides. The bonded structure 30A includes a second sub-device 20A positioned in a lower portion and includes second substrate 21 and upper sub-item 22 that is positioned above the second substrate 21 and contains an electrooptical waveguide 23 surrounded by a second oxide 24. The electrooptical waveguide 23 may be configured to guide light through the structure and may be made of an electrooptical material. The electrooptical material may be lithium niobate (LN), lithium tantalate, BTO (barium titanate), or graphene. In some cases, the electrooptical waveguide 23 may comprise lithium niobate, which may allow bandwidths greater than 200 GHz and low power operation.

The bonded structure 30A also includes a first sub-device 20 that includes a first oxide sub-item 15 is positioned above and bonded to the second sub-device, and a first photonic sub-item 16. The first oxide sub-item 15 may have a sub-micron thickness that enables optical coupling while providing structural support. In some cases, the thickness of the first oxide sub-item 15 may range from 100 nm to 200 nm. The thin oxide configuration may allow the first oxide sub-item 15 to be at least partially transparent to light, enabling optical interaction between components positioned above and below the first oxide sub-item 15.

It should be noted that the second substrate may be replaced by a substrate located above the first sub-device 20. In this case the pads may be formed at the backside of the bonded structure.

With continued reference to FIGS. 1-2, the first photonic sub-item 16 includes a first floating gate (FG1) 11A and a second floating gate (FG2) 11B. The first floating gate 11A and the second floating gate 11B may be made of crystalline silicon (c-Si) from the same silicon-on-insulator (SOI) layer used for making silicon waveguides in a photonic integrated circuit (PIC). The first floating gate 11A and the second floating gate 11B are surrounded by one or more oxide regions.

The first floating gate 11A and the second floating gate 11B may be positioned such that a vertical projection of the electrooptical waveguide 23 on a vertical plane is positioned between vertical projections of the first floating gate 11A and the second floating gate 11B on the vertical plane.

The distance between the first floating gate 11A and the electrooptical waveguide 23, and the distance between the second floating gate 11B and the electrooptical waveguide 23, may be defined by the thickness of the first oxide sub-item 15 and the thickness of cladding oxide over the electrooptical waveguide 23. In some cases, residual thicknesses of oxide used for bonding may be below 0.2 micrometers. The first floating gate 11A and the second floating gate 11B may extend parallel to the electrooptical waveguide 23 with a length typically between 0.5 mm and 2 mm.

A first electrode 12A is positioned above the first floating gate 11A, and a second electrode 12B is positioned above the second floating gate 11B. The first electrode 12A, the second electrode 12B may serve as floating gate charge control elements configured to control the charge of the respective floating gates.

In FIG. 1 the one or more oxide regions that surround the floating gates include (a) first oxide sub-item 15 that is located below the floating gates, (b) first oxide regions (Oxide-A 16A and Oxide-A 16B) located above the first and second floating gates and below the first and second electrodes, respectively, and (c) third oxide regions (Oxide-C 19) located to the sides of the floating gates.

Accordingly—the first floating gate 11A and the second floating gate 11B are embedded in high quality oxides. According to an embodiment, the third oxide regions are made of STI dielectric, the first oxide regions are made of gate oxide and pre-metal dielectric (PMD) and the first oxide sub-item is made of buried oxide (BOX). The use of high quality oxides from all sides of the first floating gate 11A and the second floating gate 11B may provide excellent retention of stored charges, enabling the floating gates to maintain their charge for long durations (years) after the charge is set by the floating gate charge control elements.

A first conductive path 13A connects the first electrode 12A to pads 19 at a top of the bonded structure 30A. A second conductive path 13B connects the second electrode 12B to the pads 19. The pads 19 provide external electrical connections for programming the first floating gate 11A and the second floating gate 11B to control the refractive index of the electrooptical waveguide 23. The first photonic sub-item 16 may also include a EFIRI (electrical field indifferent refractive index) waveguide 11C (such as but not limited to a silicon waveguide) positioned at the same layer as the floating gates and surrounded by oxide regions that include first oxide sub-item 15, first oxide region Oxide-A 16C, and third oxide regions (Oxide-C 19) located to the sides of the EFIRI waveguide.

As further shown in FIG. 2, electrical field lines 91 extend between the first floating gate 11A and the second floating gate 11B. The electrical field lines 91 pass through the electrooptical waveguide 23, demonstrating how the charged floating gates influence the refractive index of the electrooptical material through the Pockels effect. The first floating gate 11A may be charged to a different potential than the second floating gate 11B. In some cases, the first floating gate 11A and the second floating gate 11B may be charged to opposite potentials exceeding 5 Volts, so that the voltage difference between the first floating gate 11A and the second floating gate 11B is greater than 10V. The electric field generated by the charged floating gates may modify the refractive index of the electrooptical waveguide 23, enabling static tuning of the photonic device.

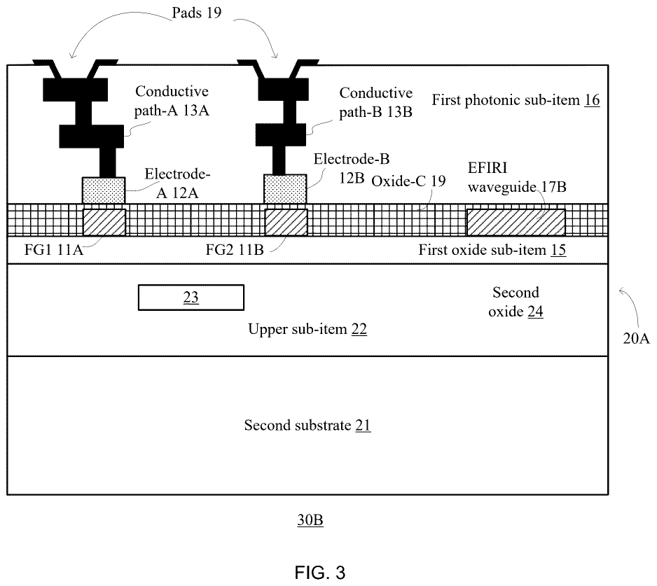

Referring to FIG. 3, a photonic device 30B is shown that differs from the bonded structure 30A of FIGS. 1-2 by the oxide configuration between the floating gates and their electrodes. Instead of having the first oxide regions (Oxide-A 16A and Oxide-A 16B) located above the first and second floating gates and below the first and second electrodes, respectively—the third oxide regions (Oxide-C 19) are located to the sides of the floating gates and above the floating gates. The first oxide sub-item 15 is still located below the floating gates. According to an embodiment the formation of the third oxide regions are followed by thermal annealing.

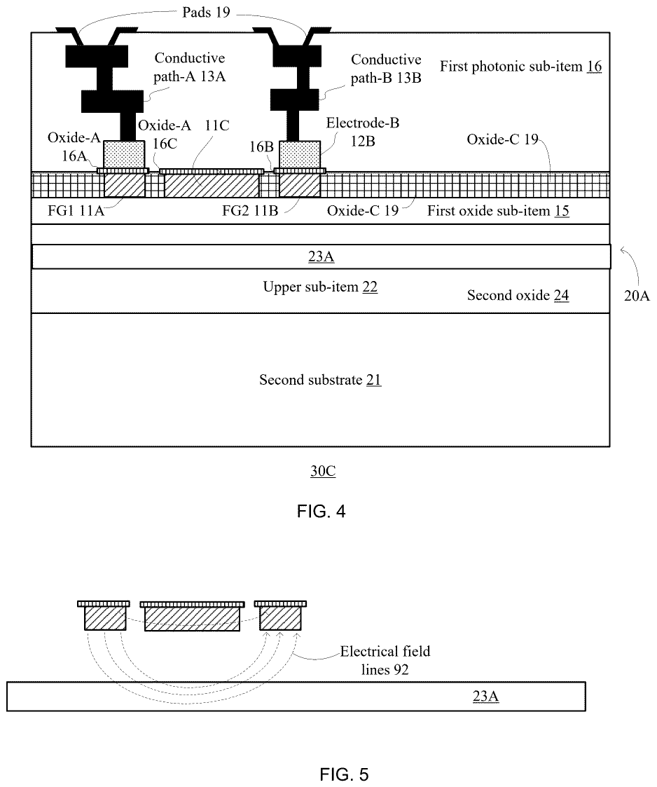

Referring to FIGS. 4-5, a photonic device 30C differs from the photonic device 20A of FIG. 1 by:
a. Having an unpatterned electrooptical layer 23A instead of one or more patterned electrooptical waveguides 23.
b. Having the EFIRI waveguide 11C located between the first and second floating gates.

The electrooptical layer 23A may comprise an unpatterned layer of electrooptical material such as lithium niobate. In some cases, a lithium niobate on insulator (LNOI) wafer may be unpatterned. In other cases, the LNOI wafer may comprise ridge or strip waveguides formed in the lithium niobate layer.

As shown in FIG. 5, electrical field lines 92 extend between the first floating gate 11A and the second floating gate 11B. The electrical field lines 92 pass through the EFIRI waveguide and the electrooptical layer 23A below. When the electrooptical layer 23A is not patterned, an evanescent field of the silicon waveguide may be coupled to the continuous electrooptical layer 23A. The electrical field lines 92 demonstrate how the charged floating gates influence the refractive index of the electrooptical layer 23A through the Pockels effect, enabling tuning of the photonic device 30C.

The modulation of a composite waveguide formed by the EFIRI waveguide and the electrooptical layer 23A may be a combination of the electrooptical (Pockels) effect in the electrooptical layer 23A and plasma dispersion effect in the silicon waveguide. The electrical field lines 92 from the first floating gate 11A and the second floating gate 11B may partially pass through the silicon waveguide and partially through the electrooptical layer 23A, enabling both modulation mechanisms to contribute to the refractive index tuning of the composite waveguide structure.

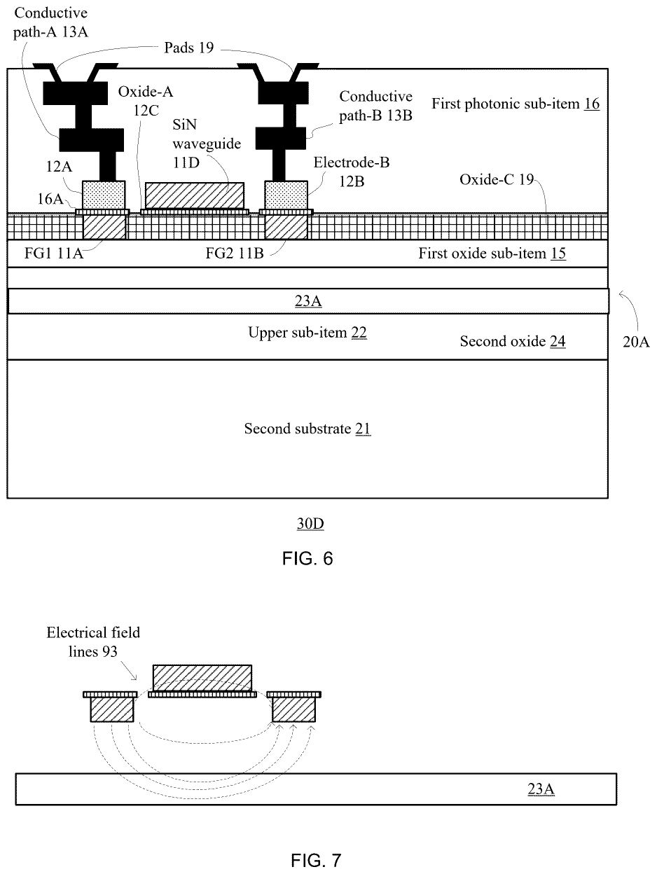

Referring to FIGS. 6-7, photonic device 30D differs from the photonic device 20A of FIG. 1 by:
a. Having an unpatterned electrooptical layer 23A instead of one or more patterned electrooptical waveguides 23.
b. Having a silicon nitride (SiN) waveguide 11D located between the first and second electrodes 12A and 12B.

As shown in FIG. 7, electrical field lines 93 extend between the first floating gate 11A and the second floating gate 11B when the first floating gate 11A and the second floating gate 11B are charged to opposite potentials. The electrical field lines 93 pass through the silicon nitride waveguide and the electrooptical layer 23A below. An evanescent field of the silicon nitride waveguide may couple to the electrooptical layer 23A, allowing the refractive index of a composite waveguide structure to be tuned based on the charge stored in the first floating gate 11A and the second floating gate 11B. The modulation of the refractive index may occur solely through the Pockels effect in the electrooptical material of the electrooptical layer 23A, as the silicon nitride waveguide does not exhibit plasma dispersion effects.

The silicon nitride waveguide may have a taper shape to enhance the evanescent field at an expense of losses increase and loss of single mode operation. The tapered configuration may increase the optical coupling between the silicon nitride waveguide and the electrooptical layer 23A.

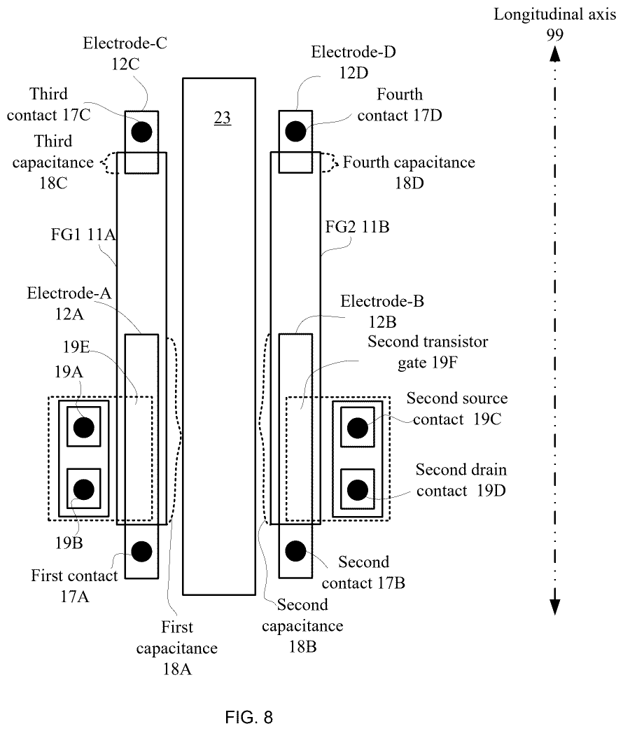

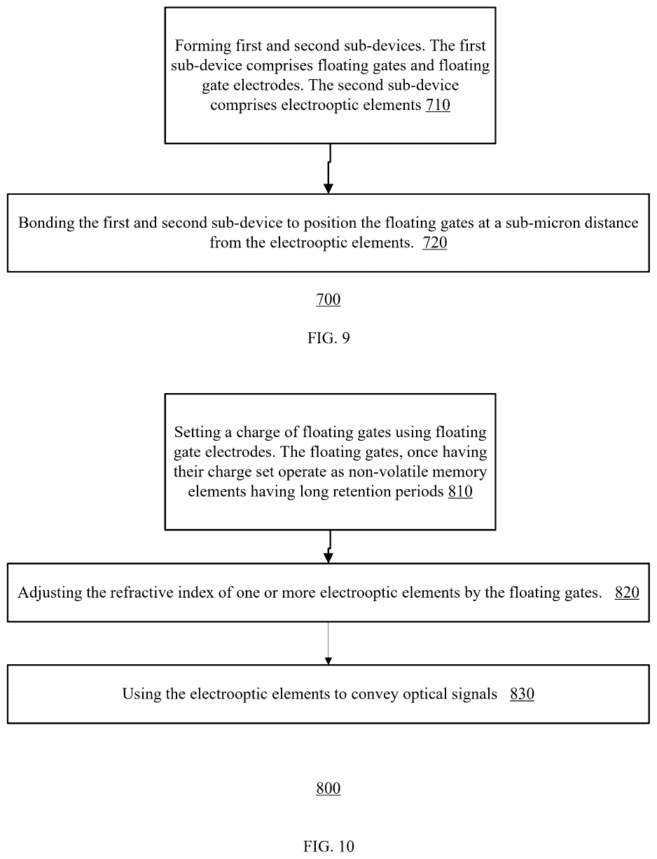

Referring to FIG. 8, a top view of a portion of a device and shows various elements located at different heights, with layers and materials positioned between these elements omitted for clarity.

The first floating gate 11A is positioned on a left side of electrooptic waveguide 23, and the second floating gate 11B is positioned on a right side of the electrooptic waveguide 23 so that the electrooptical waveguide 23 is located between the first floating gate 11A and the second floating gate 11B.

Above the first floating gate 11A, the first electrode 12A is positioned at one side along longitudinal axis 99, with a first contact 17A contacting the first electrode 12A. A first capacitance 18A is formed by a first overlap between the first electrode 12A and the first floating gate 11A. At another side along the longitudinal axis of the first floating gate 11A, the third electrode 12C is positioned with a third contact 17C contacting the third electrode 12C. A third capacitance 18C is formed by a third overlap between the third electrode 12C and the first floating gate 11A. When a voltage is applied between the first contact 17A and the third contact 17C, a majority of the voltage falls on the first capacitance 18A, as the first capacitance 18A represents a smaller capacitor with the same distance between virtual plates, and this configuration may allow programming of the first floating gate 11A.

With continued reference to FIG. 8, above the second floating gate 11B, the second electrode 12B is positioned at one side along the longitudinal axis, with the second contact 17B contacting the second electrode 12B. A second capacitance 18B is formed by a second overlap between the second electrode 12B and the second floating gate 11B. At another side along the longitudinal axis of the second floating gate 11B, a fourth electrode 12D is positioned with a fourth contact 17D contacting the fourth electrode 12D. A fourth capacitance 18D is formed by a fourth overlap between the fourth electrode 12D and the second floating gate 11B. When a voltage is applied between the second contact 17B and the fourth contact 17D, a majority of the voltage may fall on the fourth capacitance 18D, as the fourth capacitance 18D represents a smaller capacitor with the same distance between virtual plates, and this configuration may allow programming of the second floating gate 11B.

There may be, for example, a ratio of one to ten between the different overlap areas of the first capacitance 18A, the second capacitance 18B, the third capacitance 18C, and the fourth capacitance 18D. In some cases, other ratios lower than ten or higher than ten may be provided.

As further shown in FIG. 8, a first transistor is formed including a first source contact 19A and a first drain contact 19B, with a first transistor gate 19E coupled to a portion of the first floating gate 11A. A second transistor is formed including a second source contact 19C and a second drain contact 19D, with a second transistor gate 19F coupled to a portion of the second floating gate 11B. The first transistor may be configured to sense a first charge of the first floating gate 11A, and the second transistor may be configured to sense a second charge of the second floating gate 11B.

Each of the first transistor and the second transistor may be a MOS transistor with shallow trench isolation (STI) acting as a gate oxide . and a channel located at a vertical wall of a drain/source portion of the respective transistor. The first transistor may be formed as an elongated feature in a crystalline silicon layer with the channel located at the vertical wall, minimum design rule STI dielectric, and a gate coupled through the first floating gate 11A. The second transistor may be formed as an elongated feature in the crystalline silicon layer with the channel located at the vertical wall, minimum design rule STI dielectric, and a gate coupled through the second floating gate 11B.

Means for programming the first floating gate 11A and the second floating gate 11B may include voltage sources allowing application of +/−10V to control gate and tunnel gate electrodes. The first floating gate 11A and the second floating gate 11B may be charged to opposite potentials. In some cases, the first floating gate 11A may be charged to a negative potential with electrons, and the second floating gate 11B may be charged to a positive potential with holes. In other cases, the first floating gate 11A may be charged to a positive potential with holes, and the second floating gate 11B may be charged to a negative potential with electrons.

Referring to FIG. 9, a method 700 of fabricating a photonic device is shown. The method 700 begins with a step 710 where first and second sub-devices are formed. The first sub-device includes floating gates and floating gate electrodes, while the second sub-device comprises electrooptic elements. The first sub-device may include the first floating gate 11A, the second floating gate 11B, the first electrode 12A, the second electrode 12B, the third electrode 12C, and the fourth electrode 12D. The second sub-device may include the electrooptical waveguide 23 or the electrooptical layer 23A surrounded by the second oxide 24.

The method 700 proceeds to a step 720 where the first and second sub-devices are bonded to position the floating gates at a sub-micron distance from the electrooptic elements. The bonding step enables close proximity between the first floating gate 11A and the second floating gate 11B and the electrooptic elements, facilitating effective control of the refractive index through the electric field generated by the charged floating gates.

With continued reference to FIG. 9, the fabrication method may include removal of a substrate of a SiPho wafer and bonding the SiPho wafer to an LNOI wafer. A double-bonding scheme may be used where a dummy item such as a bare wafer is bonded to the first photonic sub-item 16 and a first silicon substrate is removed. The dummy item may provide temporary mechanical support for the first photonic sub-item 16 during the substrate removal process. The dummy item may be selected to have material properties that enable selective etching or removal after the bonding and substrate removal processes are completed.

In the double bonding scheme, the pads 19 for electrical connection may be opened after removing the dummy wafer. The removal of the first silicon substrate may involve selective etching processes that remove the silicon material while preserving the first oxide sub-item 15 and the first photonic sub-item 16.

In a single bonding scheme, a PIC may remain on a silicon bulk of the SiPho wafer. Etching of the LNOI wafer and pre-metal dielectric (PMD) may be performed to expose the pads 19 for electrical connection from a back side while silicon of the LNOI wafer is removed.

The first oxide sub-item 15 may use ONO (oxide-nitride-oxide) instead of standard oxide, in order to use a silicon nitride layer as an etch stop layer during silicon removal in the double bonding scheme. The ONO configuration may allow a thin layer of silicon dioxide below 200 nm to remain after silicon removal.

A first semiconductor item may be manufactured using a standard photonic IC manufacturing process that is modified to provide a thinner first oxide layer compared to conventional processing. Using the standard photonic IC manufacturing process may reduce costs and may be highly reliable. The modification to provide the thinner first oxide layer may decrease the distance between the floating gates and the electrooptic elements, thereby improving the coupling between the floating gates and the electrooptic elements and increasing the impact of the floating gates on the electrooptic elements.

As further shown in FIG. 9, a method 800 of operating the photonic device is illustrated. The method 800 begins with a step 810 where a charge of the first floating gate 11A and the second floating gate 11B is set using floating gate electrodes such as the first and second electrodes 12A and 12B of FIGS. 1, 3, 4, 6, and 8. The first floating gate 11A and the second floating gate 11B, once having their charge set, may operate as non-volatile memory elements having long retention periods.

The method 800 proceeds to a step 820 where the refractive index of one or more electrooptic elements is adjusted by the first floating gate 11A and the second floating gate 11B. The electric field generated by the charged floating gates may influence the electrooptic elements through the Pockels effect, thereby modifying the refractive index of the electrooptic elements.

The method 800 continues to a step 830 where the electrooptic elements are used to convey optical signals. Step 830 may include modulating the optical signals. The sequence of steps in the method 800 demonstrates how the charged floating gates provide static tuning of the electrooptic elements, enabling applications such as matching shoulders of Mach-Zehnder Interferometers or tuning frequencies of micro-ring resonators.

A number of implementations have been described. Nevertheless, it will be understood that various modifications may be made without departing from the spirit and scope of the disclosure. Accordingly, other implementations are within the scope of the following claims.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using optical and/or electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

The specification includes examples of dimensions and/or materials—but dimensions and the materials may be changed without departing from the spirit of the invention.

Any reference in the specification to a method should be applied mutatis mutandis to a system capable of executing the method.

Any reference in the specification to a system should be applied mutatis mutandis to a method that may be executed by the system.

The term and/or means additionally or alternatively. For example A and/or B means only A, or only B or A and B.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Any reference to the term “includes” or “having” or “including” should be applied mutatis mutandis to “consisting” and additionally or alternatively should be applied mutatis mutandis to “consisting essentially of”.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Other modifications, variations, and alternatives are also possible. The specifications and drawings are, accordingly, to be regarded in an illustrative rather than in a restrictive sense.

In the claims, any reference signs placed between parentheses shall not be construed as limiting the claim. The word ‘includes’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A photonic device, comprising:
a first item comprising one or more electrooptic elements made of an electrooptic material and surrounded by oxide;
a second item bonded to the first item, the second item comprising:
one or more waveguides;
floating gates that are made of a silicon based material and are fully surrounded by oxide; and
floating gate charge control elements that are spaced apart from the floating gates and are configured to control a charge of each of the floating gates thereby controlling a refractive index of each of the one or more electrooptic elements;
wherein each floating gate is configured to maintain its charge for long durations after the charge is set by one or more of the floating gate charge control elements; and
wherein a distance between each floating gate and an electrooptic element of the one or more electrooptic elements that is closest to the floating gate is between 100-800 nanometers; and
a substrate.

2. The photonic device of claim 1, wherein the floating gate charge control elements comprise polysilicon electrodes that are fed by conductive paths of the second item.

3. The photonic device of claim 1, wherein the floating gates comprise a first floating gate and a second floating gate.

4. The photonic device of claim 3, further comprising a first sensing transistor configured to sense a first charge of the first floating gate and a second sensing transistor configured to sense a second charge of the second floating gate.

5. The photonic device of claim 4, wherein the first floating gate is a first gate electrode of the first sensing transistor and a first oxide region between the first floating gate and the first sensing transistor is a first oxide region of the first sensing transistor, wherein a first vertical channel of the first sensing transistor is formed at a boundary between the first sensing transistor and the first oxide region.

6. The photonic device of claim 3, wherein the one or more electrooptic elements comprises an electrooptic waveguide that is located below the first floating gate and the second floating gate and wherein a vertical projection of the electrooptic waveguide on a vertical plane is positioned between vertical projections of the first floating gate and the second floating gate on the vertical plane.

7. The photonic device of claim 6, wherein the one or more waveguides, the first floating gate and the second floating gate are made of a same silicon based material.

8. The photonic device of claim 6, wherein the one or more waveguides are located at a same layer as the first floating gate and the second floating gate and to a side of the first floating gate and the second floating gate.

9. The photonic device of claim 3, wherein the one or more electrooptic elements comprises an unpatterned electrooptic layer that is located below the first floating gate and the second floating gate, and wherein a waveguide of the one or more waveguides has a vertical projection on a vertical plane that is positioned between vertical projections of the first floating gate and the second floating gate on the vertical plane.

10. The photonic device of claim 9, wherein the waveguide is made of silicon and is located at a same level as the first floating gate and the second floating gate.

11. The photonic device of claim 9, wherein the floating gate charge control elements comprise polysilicon electrodes, and wherein the waveguide is made of silicon nitride and is located at a same level as the polysilicon electrodes.

12. A method of fabricating a photonic device, comprising:
forming a first sub-device comprising floating gates made of a silicon based material and fully surrounded by oxide, and floating gate charge control elements configured to control a charge of each of the floating gates;
forming a second sub-device comprising one or more electrooptic elements made of an electrooptic material and surrounded by oxide; and
bonding the first sub-device to the second sub-device to position the floating gates at a distance between 100-800 nanometers from the one or more electrooptic elements, wherein the floating gates are configured to control a refractive index of the one or more electrooptic elements through an electric field generated by charges stored in the floating gates.

13. The method of claim 12, wherein forming the first sub-device comprises forming the floating gates from a crystalline silicon layer of a silicon-on-insulator wafer.

14. The method of claim 13, wherein forming the first sub-device further comprises forming one or more waveguides from the crystalline silicon layer.

15. The method of claim 12, wherein bonding the first sub-device to the second sub-device comprises:
bonding a dummy wafer to the first sub-device;
removing a silicon substrate from the first sub-device to expose an oxide layer; and
bonding the exposed oxide layer to the second sub-device.

16. The method of claim 12, wherein the one or more electrooptic elements comprise an unpatterned electrooptic layer made of lithium niobate.

17. A method of operating a photonic device, comprising:
setting a charge of a first floating gate and a charge of a second floating gate using floating gate charge control elements, wherein the first floating gate and the second floating gate are made of a silicon based material and are fully surrounded by oxide, and wherein the first floating gate and the second floating gate are positioned at a distance between 100-800 nanometers from one or more electrooptic elements made of an electrooptic material;
adjusting a refractive index of the one or more electrooptic elements by an electric field generated between the first floating gate and the second floating gate; and
conveying optical signals through the one or more electrooptic elements having the adjusted refractive index.

18. The method of claim 17, wherein setting the charge of the first floating gate and the charge of the second floating gate comprises charging the first floating gate to a first potential and charging the second floating gate to a second potential opposite to the first potential.

19. The method of claim 18, wherein a voltage difference between the first potential and the second potential is greater than 10 volts.

20. The method of claim 17, wherein adjusting the refractive index of the one or more electrooptic elements comprises modifying the refractive index through a Pockels effect in the electrooptic material.
